(19) United States
(12) Patent Application Publication
(10) Pub. No.: US 2010/0167915 A1
(43) Pub. Date: Jul. 1, 2010

(54) Hydrodesulphurization Nanocatalyst, Its Use and a Process for Its Production

(75) Inventors: Ali Mohajeri, Tehran (IR); Alimorad Rashidi, Tehran (IR); Kheirollah Jafari Jozani, Karaj (IR); Payman Khorami, Tehran (IR); Bahman Amini, Karaj (IR); Dorsa Parviz, Tehran (IR); Mansour Kalbasi, Tehran (IR)

Correspondence Address: ARASH BEHRAVESH, 4391 Old Dominion Dr., ARLINGTON, VA, 22207, US

(73) Assignee: RESEARCH INSTITUTE OF PETROLEUM INDUSTRY (RIPI), Tehran (IR)

(21) Appl. No.: 12/629,835

(22) Filed: Dec. 2, 2009

(30) Foreign Application Priority Data
Dec. 2, 2008 (EP) EP 08 170 413.2

(51) Int. Cl. B01J 31/06; B01J 21/18; B01J 31/02

(52) U.S. Cl. 502/159; 502/185; 502/172; 977/742

(57) ABSTRACT

A nano-supported hydrodesulphurization (HDS) catalyst is prepared for hydrodesulphurization of hydrocarbonaceous feed stock. The catalyst can be prepared through different methods and also used under milder conditions than those required for conventionally used HDS catalysts, but can also function under other hydrodesulphurization operating conditions.

### CROSS REFERENCE

The present application claims the benefit of EP 08170413.2 filed on Dec. 2, 2008, which is incorporated herein by reference in its entirety.

### TECHNICAL FIELD

The present invention relates to a hydrodesulphurization (HDS) nanocatalyst, use of the hydrodesulphurization nanocatalyst in a hydrodesulphurization process and a process for the production of a hydrodesulphurization nanocatalyst.

### BACKGROUND

In order to minimize the negative health and environmental effects of automotive exhaust emissions, legal restrictions on sulphur(s) content of fuels, especially diesel, are becoming more stringent. Germany, for instance, has passed an act limiting the sulphur in diesel and gasoline to 10 ppm from November 2001. New sulphur limits of 30 to 50 ppm for gasoline and diesel marketed in the European Community and the United States have been implemented since January 2005, and even further decreases can be expected in the future. So there is an increasing demand for producing catalysts to meet the environmental restrictions.

Gasoline, diesel and non-transportation fuels account for about 75 to 80% of the total refinery products. Most of the desulphurization processes are therefore meant to treat the streams forming these end products and hence the efficiency of the desulphurization technologies is a key point in such processes. Conventional hydrodesulphurization processes are not capable of producing zero sulphur level fuels, while maintaining other fuel requirements such as oxygen content, vapor pressure, overall aromatics content, boiling range and olefin content for gasoline, and cetane number, density, polynuclear aromatics content, and distillation 95% point for diesel fuel.

On the other hand, regarding the fact that gasoline is formed by blending straight run naphtha, naphtha from fluid catalytic cracking (FCC) units, and coker naphtha, most of the sulphur in gasoline originates from FCC naphtha. Treatment of FCC gasoline is, therefore, of great importance, while the sulphur content of the other gasoline-forming refinery streams is not a problem for the current environmental regulations. However, for yielding gasoline streams of <30 ppm S, the refinery has to treat the other sources of naphtha as well. It is currently known that a relatively high level of sulphur removal can be achieved by using conventional or advanced CoMo and NiMo catalysts. However, simultaneous hydrogenation of olefins should be minimized because it reduces the octane number. Also aromatics are not desired in the final gasoline product.

Diesel fuel is formed from straight run diesel, light cycle oil from the FCC unit, hydrocracker diesel, and coker diesel. Diesel is currently desulphurized by the hydro-treating of all blended refinery streams. To get diesel with less sulphur content the hydrotreating operation has to be more severe. For straight run diesel, sulphur removal is the only concern in hydrotreating since the other diesel specifications (e.g. cetane number, density, and polyaromatics content) are satisfactorily met.

Hydrocracker diesel, on the other hand, is usually relatively high in quality and does not require additional treatment to reduce the sulphur content.

As with gasoline, the diesel produced by the FCC and coker units normally contains up to 2.5% by weight sulphur. Both the FCC and coker diesel products have very low cetane numbers, high densities, and high aromatic and polyaromatic contents. In addition to getting desulphurized, these streams must be upgraded by high pressure and temperature processes requiring expensive catalysts. Another problem is that, at high temperatures, the hydrogenation dehydrogenation equilibrium tends to shift toward aromatics. As with gasoline desulphurization, there are many options for developing and applying advanced desulphurization technologies with simultaneous upgrading to higher diesel specifications.

Non-transportation fuels are formed from vacuum gas oils, and residual fractions from coking and FCC units. The sulphur content requirements for non-transportation fuels are less strict than for gasoline and diesel because industrial fuels are used in stationary applications while sulphur emissions can be avoided by combustion gas cleaning processes. In particular, high temperature solid adsorbents based on zinc titanate or manganese/alumina are currently receiving much attention. In practice, the major process includes the capture of sulphur oxides with calcium oxide producing calcium sulfate. Of course, for non-transportation fuels, HDS technologies can also be applied without considering other fuel specifications that must be met for gasoline and diesel fuels. It has to be expected that the sulphur level requirements will become more stringent in the near future, approaching zero sulphur emissions from burned fuels. The next generation of engines, especially fuel cell based engines, will also require fuels with extremely low (preferably zero) sulphur content. Therefore, scientists and engineers have long been involved in improving current refinery technologies and developing advanced technologies should shoot for complete sulphur removal from refinery products.

Organosulphur compounds are commonly present in almost all fractions of crude oil distillation. Higher boiling point fractions contain relatively more sulphur and the sulphur compounds are of higher molecular weight. Therefore, a wide spectrum of sulphur-containing compounds should be considered with respect to reactivity in hydrotreating processes.

Middle distillates normally contain benzothiophenes and dibenzothiophenes while the direct fractions of crude oil contain thiophenes, mercaptane sulfides and disulfides. Among these compounds, sulfides and disulfides have the highest chemical activities followed by thiophenes, benzothiophenes and dibenzothiophenes (DBT). As a result, common desulphurization processes remove sulfides and thiophenes much more easily. Deep desulphurization can also lead to the removal of benzothiophenes, but cannot affect alkylated benzothiophenes, especially those with alkyl branches on 4 and 6 positions.

The reactivity of organosulphur compounds varies widely depending on their structure and local sulphur atom environment. Low-boiling crude oil fractions mainly contain aliphatic organosulphur compounds such as mercaptanes, sulfides, and disulfides. They are very reactive in conventional hydrotreating processes and can easily be completely removed from the fuel.

In the case of higher boiling crude oil fractions such as heavy straight run naphtha, straight run diesel and light FCC naphtha, the organosulphur compounds pre-dominantly contain thiophenic rings. These compounds include thiophenes and benzothiophenes and their alkylated derivatives. These thiophene-containing compounds are more stable than mercaptanes and sulfides to be treated via hydrotreating. The heaviest fractions blended to the gasoline and diesel pools such as bottom FCC naphtha, coker naphtha, FCC and coker diesel contain mainly alkylated benzothiophenes, dibenzothiophenes (DBTs) and alkyldibenzothiophenes, as well as polynuclear organic sulphur compounds, i.e. the least reactive sulphur compounds in the HDS reaction.

HDS of thiophenic compounds proceeds via two reaction pathways. In the first pathway the sulphur atom is directly removed from the molecule (hydrogenolysis pathway), while in the second one the aromatic ring is hydrogenated and sulphur is subsequently removed (hydrogenation pathway). Both pathways occur in parallel, employing different active sites of the catalyst surface. The reaction pathway is determined by the nature of the sulphur compounds, the reaction conditions, and the catalyst used. At the same reaction conditions, DBT reacts preferably through the hydrogenolysis pathway, while for DBT alkylated at the 4 and 6 positions both the hydrogenation and hydrogenolysis routes are significant.

The conventional HDS process is usually conducted over sulfidized CoMo/Al₂O₃ and NiMo/Al₂O₃ catalysts, the performance of which, in terms of desulphurization level, activity and selectivity depends on the properties of the specific catalyst used (concentration of the active species, support properties, synthesis route), the reaction conditions (sulfidizing protocol, temperature, partial pressure of hydrogen and H₂S), nature and concentration of the sulphur compounds present in the feed stream, reactor and process design.

Alumina is the most widely used support of hydrodesulphurization catalysts. Notable feature of alumina supports is their ability to provide high dispersion of the active metal components. However, numerous chemical interactions exist between alumina and transition metal oxides. Some of the formed species are very stable and resist completing sulfidizing and therefore the catalytic activity of such catalysts is low. The coke formation during hydrodesulphurization process of petroleum fractions is another disadvantage of alumina-supported catalysts, which causes deactivation and decreases lifetime of catalysts. In hydrodesulphurization, a catalyst active surface is defined as a portion of surface occupied by metal sulfide (metal selected from group 6B of the periodic table such as molybdenum sulfide). Results show that chemical interactions between active species and support in alumina supported catalysts prevent multilayer formation of metal sulfide and therefore decrease the reactivity.

Other CoMo and NiMo catalysts have been prepared in which activated carbon supports have been used to modify the properties of the hydrodesulphurization catalysts.

U.S. Pat. No. 5,770,046 discloses a catalyst for selective hydrodesulphurization of cracked naphtha under conditions to minimize saturation of the olefin content. The carbon supported catalyst used for the HDS process is prepared by depositing group IA, IIA, IIIB, VIIIB, VIB and IB metals of the periodic table over activated carbon support.

The carbonous material supports used for the preparation of hydrodesulphurization catalysts have the advantage of eliminating the support-active metal interactions observed among the conventional supports which affects the activity of the final catalyst. These catalysts however, suffer disadvantages such as low absorption capabilities, almost no electrical, thermal properties and also their surface chemistry is not controllable with respect to new carbonous structures such as carbon nanotubes, which in turn lead to low desulphurization activities.

Embodiments of the present invention provide hydrodesulphurization nanocatalysts that overcome the problems of the prior art catalysts. The catalysts according to the present invention, for example, have an increased surface area and therefore a better activity. The more common catalysts, according to the present invention, provide for improved dispersion of the active metals over the support material, while chemical interactions between the support material and active metal are minimized. It is also an aspect of the present invention to provide catalysts that function under relatively mild operating conditions as compared to conventional catalysts.

### DETAILED DESCRIPTION

The present invention refers to a hydrodesulphurization nanocatalyst comprising a nano-structured porous carbonaceous support material, at least one active metal selected from the group 8B of the periodic table of elements and at least one active metal selected from the group 6B of the periodic table of elements.

The nanocatalyst according to the present invention may comprise the group 8B metal and the group 6B metal in a molar ratio of 0.1 to 1, for example, 0.2 to 0.5.

The content of active metals in the nanocatalyst according to the present invention may be 1 to 20% by weight, for example, 3 to 15% by weight.

Additionally, the catalyst according to the present invention may further comprise phosphorus pentoxide, for example, in amounts of from about 0.1 to about 5% by weight. Phosphorous pentoxide may act as a promoter and increases the hydrodesulphurization activity of the catalyst.

According to an embodiment of the present invention, the hydrodesulphurization nanocatalyst may comprise molybdenum and/or tungsten. The hydrodesulphurization nanocatalyst may additionally comprise cobalt and/or nickel. The nanocatalyst, according to the present invention may comprises molybdenum as the group 6B metal. In another embodiment, the nanocatalyst according to the present invention may comprise cobalt as the group 8B metal. Naturally, some differences exist CoMo and NiMo catalysts. NiMo catalysts have higher hydrogenation activities than CoMo catalysts. But hydrodesulphurization reactions with NiMo catalysts mainly proceed via the hydrogenation route. Therefore, the active metals may include Co and Mo.

The catalyst according to the present invention may comprise a binder selected from the group consisting essentially of and/or consisting of furfural alcohol, poly furfural alcohol, coal tar, polyacrylonitrile, or any combination thereof. Polyacrilonitrile, as a binder, may comprise a solution including about 15% polyacrilonitrile and about 85% dimethylformamide, in which dimethylformamide is the solvent. The binder content of the support may be in the range of about 5-40% by weight, for example, in the range of from about 5 to about 15% by weight.

According to another embodiment of the present invention, the nano-structured porous carbonaceous support material of the catalyst may be “functionalized,” such that the surface of the support material is provided with certain functional groups. These functional groups may be selected from the group consisting essentially of hydroxyl, carboxyl, amine, or any combination thereof.

The application of a functionalized support leads to superior surface chemical properties in the catalyst, thus, improving its HDS activity. For example, carboxyl functional groups, which may comprise the functional group for the practicing the invention, may improve the acidic properties of the support and thus the hydrogenation activity of the catalyst may be increased.

The catalyst according to the present invention, for example, may be in the form of pellets, cylindrical structures and/or certain size fractions obtained by sieving the catalyst. The pellets may have a diameter of 5 mm, and a height of 2 mm. The catalyst may be in select defined shapes and/or sizes in order to prevent the fixed bed reactors from choking.

The nanostructure porous carbonaceous support material comprised in the catalyst according to the present invention may have a pore volume of 0.2 to 1.2 cm³/g, for example, of 0.3 to 1.1 cm³/g and, for example, of 0.9 to 1.1 cm³/g. Furthermore, the surface area of the support material may be from about 100 to 1500 m²/g, for example, from about 400 to 900 m²/g and, for example, from about 400 to 700 m²/g.

According to an embodiment of the present invention, the support material of the catalyst may comprise carbon nanotubes, or may consist of carbon nanotubes.

The expression “consisting of” as used herein means that the respective material is entirely made of the mentioned component, e.g., the respective nano-structured support material, while it may still comprise usual additives and impurities, e.g., substances that have not been intentionally added to achieve a certain effect. The expression “comprise” as used herein means that the respective material may contain further ingredients that are not explicitly mentioned but encompass such ingredients as for example further nano-structured support material or additives.

According to a particular embodiment of the present invention, the support material may comprise single wall carbon nanotubes (SWCNT), or may consist of SWCNT. The SWCNT may have an average tube diameter of from about 1 to about 4 nm. The pore volume of these SWCNT may be from about 0.2 to about 1.2 cm³/g. The surface area of the SWCNT, according to the present invention, may be from about 500 to about 1500 m²/g. The tube length of the SWCNT of the present invention may be from about 1 to about 100 μm.

According to a particular embodiment of the present invention, the support material may comprise double wall carbon nanotubes (DWCNT), or may consist of DWCNT. The DWCNT may have an average tube diameter of from about 2 to about 5 nm. The pore volume of the DWCNT may be from about 0.2 to about 1.2 cm³/g. The surface area of the DWCNT may be in the range of from about 400 to about 700 m²/g. The tube length of the DWCNT may be from about 1 to about 100 μm.

According to a particular embodiment of the present invention, the support material of the nanocatalyst may comprise multi-wall carbon nanotubes (MWCNT), or may consist of MWCNT. The tube diameter of the MWCNT may be from about 1 to about 80 nm. The pore volume of the MWCNT may be from about 0.2 to about 1.2 cm³/g. The MWCNT may have a surface area of from about 100 to about 500 m²/g. The tube length of the MWCNT may be from about 1 to about 100 μm.

According to a particular embodiment of the present invention, the support material may comprise carbon nano-fibers, or may consist of carbon nano-fibers. The fiber diameter of these carbon nano-fibers may be from about 50 to about 100 nm. The pore volume of the carbon nano-fibers may be from about 0.2 to about 0.7 cm³/g. In one embodiment the surface area of the carbon nano-fibers may be from about 100 to about 700 m²/g. The carbon nano-fibers may have a fiber length of from about 1 to about 100 μm.

In a particular embodiment of the present invention, the support material of the nano-catalyst may comprise nano-porous carbon, or may consist of nano-porous carbon. In one embodiment, the nano-porous carbon may have a pore diameter of from about 4 to about 5 nm. The pore volume of the nano-porous carbon may be from about 0.9 to about 1.1 cm³/g. The surface area of the nano-porous carbon may be from about 800 to about 900 m²/g.

According to a particular embodiment of the present invention, the support material of the nanocatalyst may comprise carbon nano-horn, or may consist of carbon nano-horn. The pore volume of the carbon nano-horn may be from about 0.3 to about 0.5 cm³/g. The pore diameter of the carbon nano-horn may be from about 30 to about 50 nm.

According to a particular embodiment of the present invention, the support material of the nanocatalyst may comprise carbon nano-tube fibers, or may consist of carbon nano-tube fibers. The pore diameter of the carbon nanotube fibers may be from about 4 to about 8 nm. The pore volume of the carbon nanotube fibers may be from 0.8 about to about 1.2 cm³/g. The carbon nanotube fibers may have a surface area of from about 600 to about 900 m²/g.

The hydrodesulphurization nanocatalyst according to the present invention is particularly suited to be used in a process for hydrodesulphurization. Particularly, the nanocatalyst according to the present invention may be used in process for deep hydrodesulphurization. The nanocatalyst according to the present invention may be used in a process for hydrodesulphurizing petroleum fractions with boiling points in the range of from about 40 to about 700° C., wherein the petroleum fractions may include light naphtha, heavy naphtha, gasoline and gas oil. According to a further embodiment, the nanocatalyst according to the present invention may be used for hydrodesulphurizing residues, heavy oil, light crude oil and sand oil.

The present invention also relates to a process for the production of a nanocatalyst, comprising the steps of:

a) Providing the catalyst support material,

b) Providing a solution of at least one active metal,

c) Dispersing the solution onto the support material,

d) Drying the support material,

e) Calcinating the catalyst,

f) optionally increasing the temperature, and/or

g) optionally forming the catalyst to pellets.

According to some embodiments of the present invention the solution of at least one active metal may be an aqueous solution, for example, the solvent of the solution may be distilled water. In an embodiment of the present invention the solution comprises two active metals. In another embodiment of the present invention different active metals are dissolved in different solutions and dispersed onto the catalyst in consecutive impregnation steps. According to other embodiments of the present invention, the solution may additionally comprise an acid, for example, an organic acid, such as a phosphoric acid and/or citric acid.

According to an embodiment of the present invention, the support material may be provided by extruding carbon nanostructures together with a binder.

According to a further embodiment of the present invention, the support material may be provided by a method selected from the group consisting essentially of and/or consisting of arc discharge, chemical vapor deposition, catalytic growth in gas phase, laser ablation, or any combination thereof.

In an embodiment of the process according to the present invention the active metal may be deposited on the support material by impregnation, microemulsion, chemical vapor deposition, sol-gel, and/or hydrothermal deposition. In one embodiment the active metal may be deposited on the support material by impregnation. Impregnation is a simple and commercial method for catalyst preparation and can be used for large scale production of catalysts.

In an embodiment of the process according to the present invention the solution of at least one active metal may additionally comprise at least one chelating agent chosen from the group consisting essentially of and/or consisting of citric acid, olefinic acids, nitrilotriacetic acid, ethylenediaminetetracetic acid, or any combination thereof. Citric acid, as a chelating agent, is very cheap and effective for providing multilayer active species.

According to an embodiment of the process according to the present invention, at least one active metal may be cobalt and the solution of the active metal may be provided by dissolving a cobalt salt selected from the group of cobalt nitrate, acetate, carbonate, sulfate, and thiocyanate.

In another embodiment of the process according to the present invention, cobalt may be used in the form of an organometallic compound.

According to an embodiment of the present invention, at least one active metal may be molybdenum which may be added in the form of its salt selected from the group of ammonium heptamolybdate, ammonium molybdate, sodium molybdate, and molybdenum oxides. In a further embodiment the active metal molybdenum may be added as an organometallic compound.

Application of the active metal as an organometallic compound may provide for a particular formation of nano-structured active metal structures on the support material.

According to another embodiment of the present invention, the active metal oxides (metal selected from group 8B and/or 6B of the periodic table) may be synthesized as a nanostructure and dispersed on catalyst support.

According to a particular embodiment of the present invention the metal oxides to be dispersed over the nano-structured support may be synthesized in nano-scale through methods such as hydrothermal, chemical vapor deposition, microemulsion and sol-gel, and/or dispersed on nano-structured support.

According to another alternative embodiment of the present invention, metals to be deposited on the support may be prepared in the form of nano-structured sulfides, then dispersed on the nano-structured support, in which case the sulfidation step may be eliminated and the catalyst may be used directly in a hydrodesulfurization process.

According to another alternative embodiment of the present invention the metal sulfide nanostructures to be deposited on the support may be prepared through the method of microemulsion and/or chemical vapor deposition.

In a particular embodiment of the process according to the present invention, the process may additionally comprise the step of sulfidizing the catalyst. This sulfidizing step may take place in any reactor, for example, in a fixed bed reactor. Sulfidizing may be performed in the presence of any hydrocarbon fraction that comprises a sulfur containing species.

A hydrocarbon fraction that may be used in this invention may include an ISOMAX fraction comprising 1% by weight of dimethyl disulfide. However, any other liquid hydrocarbon fraction comprising 1% by weight or more dimethyl sulfide can be used for this purpose.

ISOMAX is the product of the “ISOMAX unit” in oil refineries. In an “ISOMAX unit”, heavy hydrocarbons such as fuel oil and vacuum gas oil are converted (cracked) to light and valuable products such as middle distillates. The ISOMAX process takes place at high temperatures and pressures, and hence the sulfur content of ISOMAX is very low.

Sulfidation may be performed at a liquid hourly space velocity (LHSV) of from about 1 to about 10 hr-1. In a further embodiment, sulfidation may be performed at a pressure of from about 5 to about 60 bar (0.5-6 MPa). The temperature at which sulfidation may be performed is from about 250 to about 400° C. The hydrogen/hydrocarbon ratio may be from about 100 to about 500 Nm³/m³.

According to an embodiment of the process according to the present invention, the drying step may be performed at temperatures of from about 50° C. to about 200° C., for example, from about 100° C. to about 150° C., such as from about 120° C. In a further embodiment of the process according to the present invention, the drying step may be performed for from about 4 to about 24 hours, for example, from about 5 to about 15 hours and such as from about 6 to about 12 hours. Calcining of the catalyst may be performed at temperatures from about 350° C. to about 600° C., for example, from about 400° C. to about 500° C., such as about 450° C. Calcining may be performed in a nitrogen atmosphere.

The present invention further relates to a process for hydrodesulphurizing petroleum products by application of a catalyst. Hydrodesulphurization is among one of the processes used for treating sulphur-containing gas and oil streams in refineries. According to the process the sulphur-containing hydrocarbon streams may be treated over a catalytic bed, under different operating conditions that are dictated by their nature (check the table below for the operating conditions corresponding to some typical hydrocarbon streams). A hydrodesulphurization process may be performed in the presence of H₂-containing gas, which may react with the sulphur-containing compounds and may convert them to H₂S which may later be neutralized and separated.

Exemplary Operating Conditions

| | Pressure | LHSV | Temperature |
|---|---|---|---|
| Fuel Type | (Mpa) | (1/hr) | (° C.) |
| Naphtha | 1.38-5.17 | 2-6 | 290-370 |
| (gasoline) | | | |
| Kerosene/Gas | 3.45-10.30 | 0.5-3 | 315-400 |
| oil/diesel fuels | | | |
| FCC feed pretreat | 6.90-20.70 | 0.5-2 | 370-425 |

One advantage of the catalyst according to the present invention, is that the catalyst functions even at conditions that are milder than the typical operating conditions of conventional catalysts. Particularly, the catalyst of the present invention may be used in a process that occurs at pressures of from about 0.5 to about 6 MPa and temperatures of from about 250 to about 400° C. A further advantage is that the catalyst of the present invention may be used with a broad variety of feedstocks. Particularly, the present catalysts can be used in order to desulphurize hydrocarbon feedstocks with boiling points in a range of from about 40 to about 700° C.

### EXAMPLES

The following examples are provided to illustrate embodiments of the invention and the method for the application thereof, and the scope of the invention is not limited thereto.

### Example 1

A solution including 2.46 g of a cobalt nitrate, 2.76 g of ammonium heptamolybdate and 30.6 g of distilled water was prepared. The metal content of the solution was then impregnated on 18 g of single wall carbon nanotubes of a 20-100 mesh size. The catalyst was then dried at 120° C. for six hours. The calcination process was performed in a temperature-programmed electric furnace under a nitrogen atmosphere, according to which, starting from room temperature, the temperature was changed at a rate of 4° C./min to 100° C. and kept constant for two hours. The temperature was then increased to 450° C. at a rate of 2° C./min and kept constant for 4 hours. The resulting catalyst was pressed to form pellets of 5 mm in diameter and 2 mm in height. The catalyst is labeled CoMo10/SWNT.

### Example 2

A paste including 26.7 g of binder (15% polyacrylonitrile+85% Dimethylformamide) and 18 g of multi-wall carbon nanotube was prepared and extruded in cylindrical shape. The mixture was then dried at 120° C. for six hours. The calcining process was performed in a temperature-programmed electric furnace under a nitrogen atmosphere, according to which, starting from room temperature, the temperature was changed at a rate of 2° C./min to 500° C. and kept constant for one hour. The resulting mixture was used as support. A solution including 3.21 g of a cobalt nitrate, 2.64 g of molybdenum oxide, 0.72 g of phosphoric acid, 4.63 g of citric acid and 12.6 g of distilled water was prepared. The metal content of the solution was then impregnated on the support. The catalyst was then dried at 120° C. for six hours and calcinated as in example 1. The catalyst is labeled CoMo10-Ci-P/CNT-PAN15-1.

### Example 3

A solution including 3.87 g of a cobalt nitrate and 23 g of distilled water was prepared. The metal content of the solution was then impregnated on 18 g of multi-wall carbon nanotube of a 20-100 mesh size. The catalyst was then dried at 120° C. for 12 hours and calcinated as in example 1. In a second step a solution of 4.22 g of ammonium heptamolybdate and 23 g of water was prepared, used for impregnation of the catalyst in the previous step and the catalyst was then dried at 120° C. for 12 hours and calcinated as in example 1. The resulting catalyst was used to form pellets of the same description as in example 1. The catalyst is labeled CoMo10-2S/CNT.

### Example 4

A solution including 3.21 g of a cobalt nitrate, 3.58 g of ammonium heptamolybdate, 4.63 g of citric acid, and 23 g of distilled water was prepared. The metal content of the solution was then impregnated on 18 g of multi-wall carbon nanotube of a 20-100 mesh size. The catalyst was then dried at 120° C. for six hours and calcinated and pelletized as in example 1. The catalyst is labeled CoMo10-Ci/CNT.

### Example 5

A solution including 3.21 g of a cobalt nitrate, 3.58 g of ammonium heptamolybdate, 0.72 g of phosphoric acid, and 25 g of distilled water was prepared. The metal content of the solution was then impregnated on 18 g of multi-wall carbon nanotube of a 20-100 mesh size. The yielded catalyst was then dried 120° C. for six hours and calcinated and pelletized as in example 1. The catalyst is labeled CoMo10-P/CNT.

### Example 6

A solution including 2.26 g of polyethylene glycole (MW 190-210), 7 g of ammonium heptamolybdate, and 25-30 g of distilled water was prepared and neutralized using an ammonia solution. The colorless solution turned milky upon heating. The solution was dried for about 2-3 hours at 120° C., to give a green-yellow powder, which was then heated in a temperature-programmed electric furnace under air atmosphere starting from room temperature to 250° C. at a rate of 5° C./min and kept constant at this value for one hour. The temperature was then increased to 500° C. at a rate of 5° C./min and kept constant for 1.5 hours. This procedure is a method used for molybdenum oxide nanoparticles synthesis.

### Example 7

Hydrodesulphurization was performed using the nanocatalysts CoMo10/SWNT, CoMo10-Ci-P/CNT-PAN15-1, and CoMo10-2S/CNT. An alumina supported catalyst (CoMo15/Alumina) was also used for comparison. Naphtha was used as feed for catalyst evaluation. Sulphur content of feed is 1270 ppm (by mass) and feed analysis presented in table 1. The hydrodesulphurization process was performed in a stainless steel fixed bed reactor using 14 ml of catalyst in each test run. All of the catalysts were evaluated under similar operating conditions. An ISOMAX solution containing 1% of dimethyl disulfide was used to sulfiding the catalysts.

After catalyst loading, the reactor temperature was changed from room temperature to 180° C. at a rate of 40° C./hr under a hydrogen atmosphere and then the sulfidizing feed was injected. The feed had a constant LHSV of 2 hr⁻¹. After the feed injection, the temperature was changed to 260° C. at a rate of 20° C./hr and then to 310° C. at rate of 10° C./hr and kept at this temperature for 12 hours. The sulfidizing step was carried out with a hydrogen/feed ratio of 175 NI/I and pressure of 30 bar. After this step, the reaction product (collected in a condenser) was discharged and the hydrodesulphurization started with naphtha as the feed in a temperature of 310° C., pressure of 15 bar, LHSV of 4 hr⁻¹ and hydrogen/feed ratio of 175 NI/I. This reaction was performed continuously for 96 hours and a final sample after this time has been used for total sulphur analysis. Table 2, provides a comparison between CNT supported catalysts and conventional alumina catalyst.

TABLE 1
Feed analysis of the desulphurization feed used in this experiment

| | |
|---|---|
| Density at 15.56° C. | 0.7507 gr/ml |
| Color (ASTM D156) | +30 |
| Aromatics | 12.5 Vol. % |
| Naphthenics | 37.5 Vol. % |
| Olefins | Trace |
| IBP at 760 mmHg | 106° C. |
| 10% Vol. | 114° C. |
| 30% Vol. | 116° C. |
| 50% Vol. | 120° C. |
| 70% Vol. | 126° C. |
| 90% Vol. | 136° C. |
| 95% Vol. | 141° C. |
| FBP | 163° C. |

TABLE 2
Total sulphur comparison between hydrodesulphurization products

| Catalyst | Total sulphur in product (ppm) |
|---|---|
| CoMo10/SWNT | 10 |
| CoMo15/Alumina | 100 |
| CoMo10-Ci-P/CNT-PAN15-1 | 70 |
| CoMo10-2S/CNT | 20 |

### Example 8

Comparisons between the operating conditions required for the best performance and also the hydrodesulphurization activity of the catalysts in the prior art and the nanocatalyst of the present invention were also performed (Table 3). Naphtha was used as the feed throughout the experiments. The hydrodesulphurization activity was defined as:

$$\frac{( sulfur content of feed - sulfur content of product )}{sulfur content of feed} \times 100$$

As is evident, the catalyst of the present invention requires relatively moderate operating conditions, and leads to higher HDS activities, which shows a very good hydrodesulphurization performance.

TABLE 3
Comparisons between the desulphurization activity of the catalysts
in the prior art and the catalyst of the present invention

| | | | | Sulphur | Sulphur | | |
|---|---|---|---|---|---|---|---|
| | Metal | | | content | content | | |
| | content | Temperature | Pressure | of feed | of product | HDS | |
| Patent No. | (Co + Mo)% | (° C.) | (bar) | (ppmw) | (ppmw) | activity | Catalyst |
| U.S. Pat. No. 5,770,046 | 6 | 270 | 20.5 | 1600 | 361 | 77.4 | Catalyst I* |
| U.S. Pat. No. 5,770,046 | 6 | 285 | 20.5 | 1600 | 139 | 91.3 | Catalyst I* |
| U.S. Pat. No. 5,770,046 | 6 | 285 | 20.5 | 1600 | 99 | 93.8 | Catalyst I* |
| U.S. Pat. No. 5,770,046 | 6 | 270 | 20.5 | 1600 | 353 | 77.9 | Catalyst II |
| U.S. Pat. No. 5,770,046 | 6 | 286 | 20.5 | 1600 | 184 | 88.5 | Catalyst II |
| U.S. Pat. No. 5,770,046 | 6 | 300 | 20.5 | 1600 | 106 | 93.4 | Catalyst II |
| U.S. Pat. No. 5,770,046 | 6 | 285 | 20.5 | 1600 | 255 | 84.1 | Catalyst III |
| U.S. Pat. No. 5,770,046 | 6 | 300 | 20.5 | 1600 | 98 | 93.9 | Catalyst III |
| U.S. Pat. No. 5,770,046 | 6 | 300 | 20.5 | 1600 | 170 | 89.4 | Catalyst IV |
| U.S. Pat. No. 5,770,046 | 6 | 285 | 20.5 | 1600 | 130 | 91.9 | Catalyst V |
| U.S. Pat. No. 5,770,046 | 6 | 300 | 20.5 | 1600 | 72 | 95.5 | Catalyst V |
| This invention | 5 | 310 | 15 | 1270 | 40 | 96.9 | CoMo5/SWNT |
| This invention | 10 | 310 | 15 | 1270 | 20 | 98.4 | CoMo10/MWNT |
| This invention | 10 | 310 | 15 | 1270 | 10 | 99.2 | CoMo10/MWNT |
| This invention | 10 | 310 | 15 | 2400 | 20 | 99.2 | CoMo10/MWNT |
| This invention | 10 | 330 | 10 | 2400 | 5 | 99.8 | CoMo10/MWNT |

1. A hydrodesulphurization nanocatalyst, comprising:
a nano-structured porous carbonaceous support material, selected from the group consisting essentially of carbon nanotubes, carbon nano-fibres; nano-porous carbon, carbon nano-horn, carbon nanotube fibres, or any combination thereof;
at least one active metal selected from the group 8B of the periodic table of elements; and
at least one active metal selected from the group 6B of the periodic table of elements.

2. The hydrodesulphurization nanocatalyst according to claim 1, wherein the molar ratio of the group 8B metal to group 6B metal is from about 0.1 to about 1.

3. The hydrodesulphurization nanocatalyst according to claim 1, wherein the content of active metals in the nanocatalyst is from about 1 to about 20 percent by weight.

4. The hydrodesulphurization nanocatalyst according to claim 1, wherein the catalyst comprises phosphorous pentoxide in amounts of from about 0.1 to about 5 percent by weight.

5. The hydrodesulphurization nanocatalyst according to claim 1, wherein the group 8B metal is cobalt, nickel, or a combination thereof.

6. The hydrodesulphurization nanocatalyst according to claim 1, wherein the group 6B metal is molybdenum, tungsten, or any combination thereof.

7. The hydrodesulphurization nanocatalyst according to claim 1, wherein the catalyst further comprises a binder.

8. The hydrodesulphurization nanocatalyst according to claim 7, wherein the binder is selected from a, group consisting essentially of furfural alcohol, polyfurfural alcohol, coal tar, polyacrylonitrile, or any combination thereof.

9. The hydrodesulphurization nanocatalyst according to claim 1, wherein the nano-structured porous carbonaceous support material is functionalized.

10. The hydrodesulphurization nanocatalyst according to claim 1, wherein the nano-structured porous carbonaceous support material is functionalized functional groups selected from the group consisting essentially of hydroxyl, carboxyl, amine, or any combination thereof.

11. Use of the catalyst according to claim 1 in a hydrodesulphurization process.

12. A process for the production of a nanocatalyst, comprising the steps of:
providing a support material for a catalyst,
providing a solution of at least one active metal,
dispersing the solution onto the support material,
drying the support material, and
calcinating the catalyst.

13. The process according to claim 12, wherein at least one active metal is cobalt and wherein organometallic compounds of cobalt are used.

14. The process according to claim 12, wherein at least one active metal is molybdenum and wherein organometallic compounds of molybdenum are used.
